(19) United States
(12) Patent Application Publication
(10) Pub. No.: US 2026/0312806 A1
(43) Pub. Date: Oct. 8, 2026

(54) EFFICIENT AND SECURE ACCESS AUTHENTICATION SYSTEM FOR USER EQUIPMENT AND MASSIVE MACHINE-TYPE COMMUNICATION DEVICE

(71) Applicant: KWANGWOON UNIVERSITY INDUSTRY-ACADEMIC COLLABORATION FOUNDATION, Seoul (KR)

(72) Inventors: Ji Hyeon Ryu, Seoul (KR); Na Ryun WOO, Seoul (KR); Tae Woong KANG, Yongin-si (KR)

(21) Appl. No.: 19/357,276

(22) Filed: Oct. 14, 2025

(30) Foreign Application Priority Data
Mar. 28, 2025 (KR) 10-2025-0040657

(51) Int. Cl. H04L 9/30; H04L 9/32

(52) U.S. Cl. CPC H04L 9/3026; H04L 9/321

(57) ABSTRACT

The present disclosure describes access authentication systems and methods. The access authentication system according to the present disclosure is a lightweight authentication method utilizing an extended Chebyshev chaotic map, and this method improves the security and efficiency of 5G networks and is a secure authentication protocol resistant to various attacks.

### CROSS-REFERENCE TO RELATED APPLICATIONS

This application claims priority to and the benefit of Korean Patent Application No. 10-2025-0040657 filed on Mar. 28, 2025, in the Korean Intellectual Property Office, the disclosure of which is incorporated herein by reference in its entirety.

### BACKGROUND

### Field

The present disclosure relates to 5G-Authentication and Key Agreement (AKA), and more specifically, to an access authentication system that reduces computational load compared to conventional 5G-AKA.

### Description of the Related Art

The description described in this section merely provides background information on the embodiments described in the present disclosure and does not necessarily constitute prior art.

5G Authentication and Key Agreement (5G-AKA) is an authentication protocol that performs mutual authentication and security key establishment between a user and a network in 5G networks. 5G-AKA protects identity of a User Equipment (UE) and ensures the integrity of data and signals. 5G-AKA performs mutual authentication between a User Equipment (UE) and a network and uses an Authentication Server Function (AuSF) and a Unified Data Management (UDM).

5G-AKA offers enhanced security compared to Evolved Packet System-AKA (EPS-AKA) used in 4G LTE by strengthening the key hierarchy. However, this enhanced security comes at the cost of increased computational burden on the UE and network. In particular, the high computational load poses a significant burden in the authentication process for large-scale devices such as IoT, an autonomous vehicle (V2X), an Intelligent Transport System (ITS), and machine-to-machine (M2M) in smart factories. Therefore, a method is needed that reduces the computational load during the authentication process while maintaining enhanced security.

### SUMMARY

An object of the present disclosure is to provide an access authentication method with significantly improved security and performance compared to the existing 5G-AKA protocol and the latest protocol.

The present disclosure is not limited to the above-mentioned object, and other objects not mentioned will be clearly understood by those skilled in the art from the description below.

A registration method for access authentication according to the present disclosure for solving the above-described problem is a registration method for access authentication in a 5G network including a serving network, a key generation center, and a User Equipment, the registration method including: (a) receiving an ID from the serving network or the User Equipment and selecting an encryption key by means of the key generation center; (b) calculating a Chebyshev polynomial using the ID and the encryption key by means of the key generation center; and (c) transmitting a result value of the Chebyshev polynomial calculated in the (b) and the encryption key to the serving network or the User Equipment by means of the key generation center.

An access authentication method according to the present disclosure for solving the above-described problem is an access authentication method between the serving network and the User Equipment that performs the registration method for the access authentication according to the present disclosure, the access authentication method including: (a) calculating the Chebyshev polynomial using a random number (xᵢ) and sending an authentication request message including the calculation value of the Chebyshev polynomial to the serving network by means of the User Equipment; (b) verifying validity of the authentication request message received from the User Equipment by means of the serving network; (c) calculating the Chebyshev polynomial using a random number (yⱼ) when the authentication request message is valid, generating a session key using the calculation value of the Chebyshev polynomial, and sending the session key to the User Equipment by means of the serving network; and (d) verifying the validity of the session key by means of the User Equipment.

A registration method for access authentication according to the present disclosure for solving the above-described problem is a registration method for access authentication in a 5G network including a serving network, a key generation center, and n machine-type communication devices grouped together, the registration method including: (a) receiving IDs from the n machine-type communication devices and selecting an encryption key by means of the key generation center; (b) calculating a Chebyshev polynomial using the IDs and the encryption key by means of the key generation center; (c) transmitting a result value of the Chebyshev polynomials calculated in the (b) and the encryption key to the n machine-type communication devices by means of the key generation center; and (d) transmitting information about the n machine-type communication devices to the serving network by means of the key generation center.

An access authentication method according to the present disclosure for solving the above-described problem is an access authentication method between the n machine-type communication devices and the serving network that perform the registration method for access authentication according to the present disclosure, the access authentication method including: (a) sending its own information to a group leader by means of the machine-type communication device; (b) sending an aggregate authentication request message to the serving network using information received from the machine-type communication device belonging to the group by means of the group leader; (c) verifying validity of the aggregate authentication request message received from the group leader by means of the serving network; (d) when the aggregate authentication request message is valid, generating a session key and sending a message containing the session key to the machine-type communication device by means of the serving network; (e) verifying the message containing the session key and calculating the session key by means of the machine-type communication device; and (f) the group leader and the serving network verifying the validity of the aggregate authentication.

Other specific details of the present disclosure are included in the detailed description and drawings.

According to one aspect of the present disclosure, a communication method based on the extended Chebyshev chaotic map satisfies the Discrete Logarithm problem and the Diffie-Hellman problem and provides high security. Furthermore, the operation speed is faster than existing asymmetric signature algorithms and public-key encryption methods, reducing computational costs.

According to another aspect of the present disclosure, operations based on the extended Chebyshev chaotic map have advantages in terms of bandwidth and computation cost, as they can reduce communication costs and perform fast operations.

The effects of the present disclosure are not limited to the effects mentioned above, and other effects not mentioned will be clearly understood by those skilled in the art from the description below.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a simplified configuration diagram of a network architecture of 5G-AKA.

FIG. 2 is a reference diagram for a UE authentication process of 5G-AKA.

FIG. 3 is a reference diagram for a serving network registering its information with a key generation center.

FIG. 4 is a reference diagram for a User Equipment registering its information with the key generation center.

FIG. 5 is a reference diagram for a machine-type communication device registering its information with the key generation center.

FIG. 6 is a reference diagram for an authentication procedure between the User Equipment and a serving network.

FIG. 7 is a reference diagram for an authentication procedure between a massive machine-type communication device and a serving network.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

An access authentication system described in the present disclosure has a network configuration identical to that of the conventional Authentication and Key Agreement (5G-AKA). However, the access authentication system described in the present disclosure uses a communication protocol different from that of 5G-AKA. To better understand the advantages of the access authentication system described in the present disclosure, 5G-AKA will be described first.

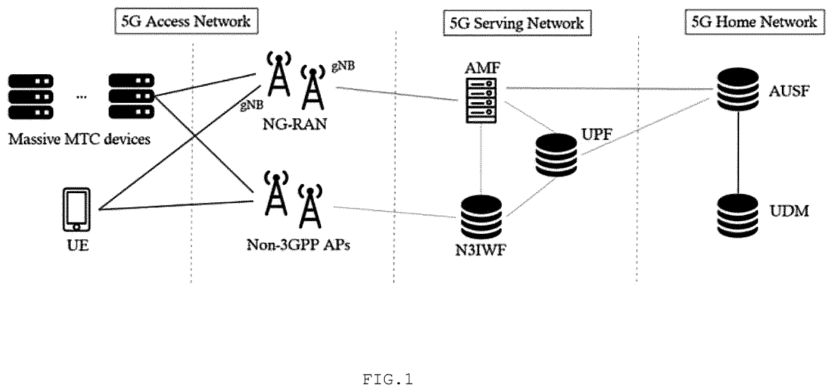

FIG. 1 is a simplified configuration diagram of a network architecture of 5G-AKA.

Referring to FIG. 1, the network includes a user equipment (UE), a machine-type communication (MTC, Machine to Machine) device, a base station (gNB, Next Generation NodeB), an access and mobility management function (AMF), an authentication server function (AUSF), and a unified data management (UDM). The user equipment (UE) refers to general user equipment such as smartphones and laptops. The machine-type communication (MTC) device refers to devices that do not require direct human intervention, such as the Internet of Things (IoT). In the present disclosure, descriptions of the user plane function (UPF) and the non-3GPP interworking function (N3IWF), which are relatively less important in the authentication procedure, are omitted. In addition, the present disclosure may refer to all contents described in 3GPP TS 33.501, “Security architecture and procedures for 5G System.

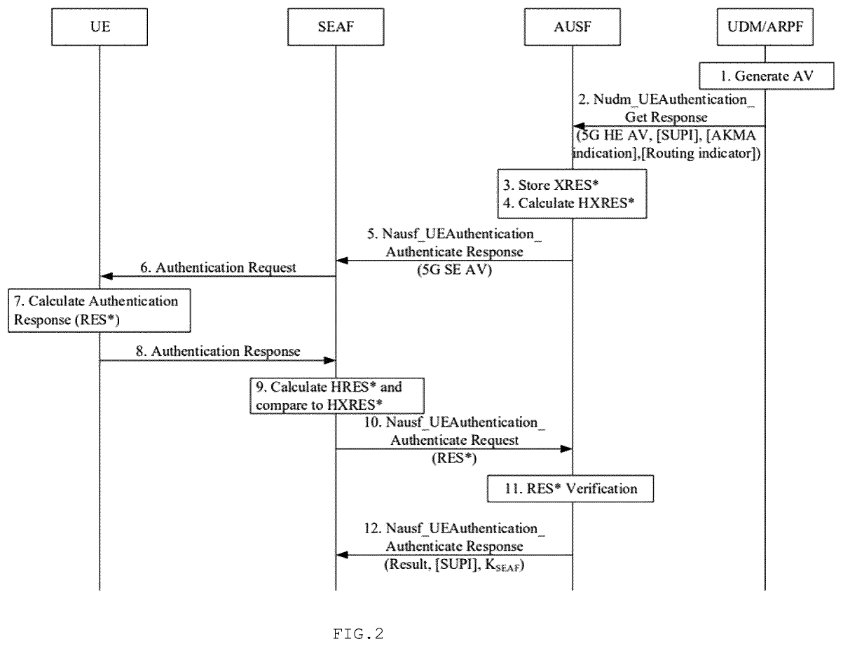

FIG. 2 is a reference diagram for a UE authentication process of 5G-AKA.

Referring to FIG. 1 and FIG. 2, the UE authentication procedure of 5G-AKA is briefly described as follows.

### 1. Authentication Request

The UE attempts to connect to the 5G network and transmits its temporary ID (SUCI, Subscription Concealed Identifier) to the Access and Mobility Management Function (AMF) via the gNB (base station).

### 2. Network Authentication Request (Authentication Vector Request)

The AMF forwards the authentication request to AUSF. The AUSF responds by generating an Authentication Vector (AV) from Authentication Credential Repository and Processing Function (UDM/ARPF).

### 3. Transmitting Random Number RAND and Response RES

The AUSF sends an authentication request including a random number RAND to the UE. The UE uses the stored authentication key K and RAND value to generate the response value RES and transmits the response value to the network.

### 4. Server-Side Verification

Within the serving network, the Security Anchor Function (SEAF) and AUSF verify whether the received RES value matches an expected response value (EXP-RES). When the authentication is successful, the SEAF generates and shares a security key (KaUSF, Key for Authentication Server Function).

### 5. Set Up Security Key

The UE and the serving network establish a session encryption key (K-NAS, K-GNB, or the like) to ensure secure communication.

The current standard, 5G-AKA, has security deficiencies and vulnerability to attacks, including PFS/PBS, untraceability, and denial-of-service DOS attacks. Furthermore, due to the lack of a 3GPP standard for massive machine-type communication (mMTC), all devices should undergo a full network authentication process to connect to the network. This results in severe signaling congestion and high costs.

The present disclosure describes an access authentication system that addresses these shortcomings. The access authentication system according to the present disclosure is a lightweight authentication method utilizing an extended Chebyshev chaotic map, and this method improves the security and efficiency of 5G networks and is a secure authentication protocol resistant to various attacks.

The extended Chebyshev chaotic map will be described. A Chebyshev polynomial is a common solution to a Chebyshev differential equation for integer values of n. The chaotic map is used in an authentication scheme for a simple computation. A Chebyshev polynomial which has a degree of n≥0 and satisfies x∈(−∞, ∞) is defined as follows.

$${T}_{n + 2} ( x ) = 2 x \cdot {T}_{n + 1} ( x ) - {T}_{n} ( x )$$

Additionally, the initial terms are defined as follows.

$${T}_{0} ( x ) = 1 , {T}_{1} ( x ) = x$$

Precomputing modular operations (mod q) using a shared q ensures that the results remain within the range [0, q], preventing excessive divergence of the results even when x extends to values close to (−∞, ∞). The extended Chebyshev chaotic map is a well-known technique, so a detailed description is omitted. First, symbols to be used in describing the access

authentication system according to the present disclosure are explained.
q: a large prime number
P: variable (P∈R (−∞, ∞))
kᵢ: private key of i
SK: session key
KGC: key generate center
UE: User Equipment
MD: machine-type communication device (MTC device)
SN: serving network
UEᵢ: i-th user equipment
MDᵢ: i-th machine-type communication device (MTC device)
SNⱼ: j-th serving network
ID_{UEi}: real identity of UEᵢ
ID_{MDi}: real identity of MDᵢ
ID_{SNj}: real identity of SNⱼ
GID: group leader ID of massive MTC device
T: timestamp
H: hash function (secure one-way hash function)
Tₐ(P) mod q: extended Chebyshev polynomial
ENC_{Pi}: encrypted data using Pᵢ
MAC: authentication code message (a message authentication code)
AMAC: aggregation message authentication code
⊕: Bitwise XOR operation
∥: concatenation operation

The access authentication system according to the present

disclosure includes a key generation center KGC, a serving network SN, and a User Equipment UE.

### <System Setup Step>

The key generation center KGC selects a large prime number q and generates a first hash function H₁ and a second hash function H₂.

### <Registration Step>

### Serving Network Registration

The serving network SNⱼ registers its information with the key generation center KGC.

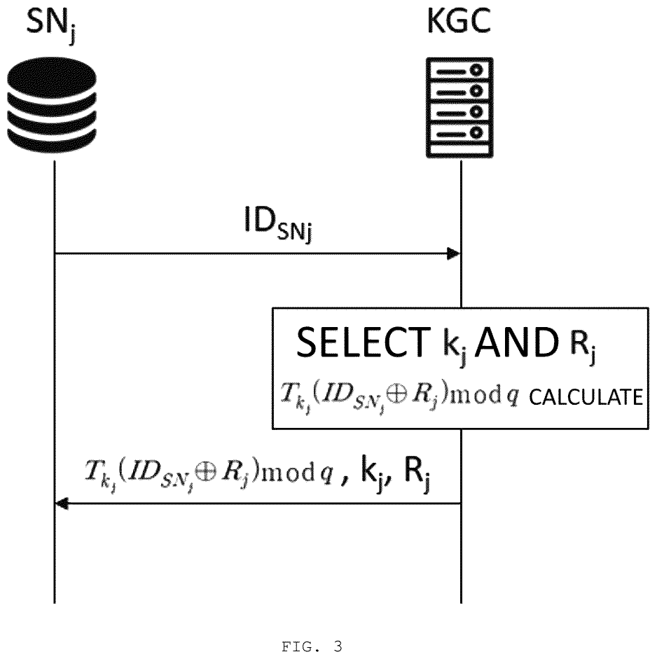

FIG. 3 is a reference diagram for a serving network registering its information with the key generation center.

Referring to FIG. 3, the serving network SNⱼ first sends its ID ID_{SNj} to the key generation center KGC. Next, the key generation center KGC selects a private key kⱼ and a public key Rⱼ of the serving network SNⱼ. The key generation center KGC then calculates the Chebyshev polynomial below using the serving network's ID ID_{SNj} and the public key Rⱼ.

$${T}_{{k}_{j}} ( {ID}_{{SN}_{j}} ⊕ {R}_{j} ) mod q$$

Moreover, the serving network SNⱼ receives the private key kⱼ, public key Rⱼ, and the calculation result value of the Chebyshev polynomial from the key generation center KGC.

### User Equipment Registration

The User Equipment UE registers its information with a key generation center KGC.

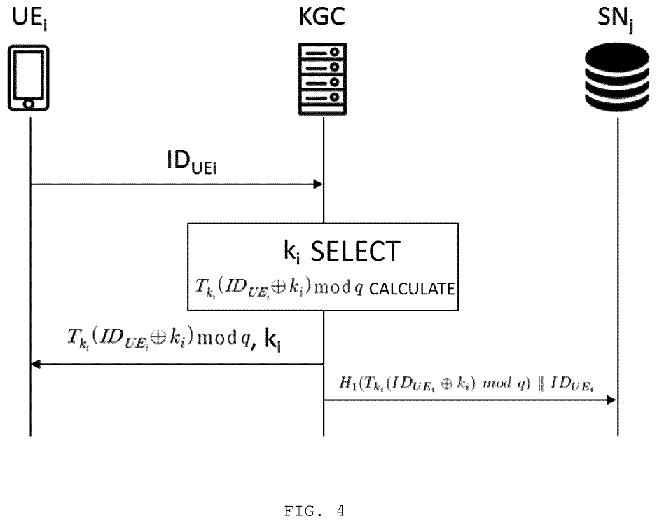

FIG. 4 is a reference diagram for the User Equipment registering its information with the key generation center.

Referring to FIG. 4, the User Equipment UEᵢ first sends its ID ID_{UEi} to the key generation center KGC. Next, the key generation center KGC selects a private key kᵢ for the User Equipment UEᵢ. The key generation center KGC then calculates the Chebyshev polynomial below using the User Equipment's ID ID_{UEi} and the private key kᵢ.

$${T}_{{k}_{i}} ( {ID}_{{UE}_{i}} ⊕ {k}_{i} ) mod q$$

Moreover, the User Equipment UEᵢ receives the private key kᵢ and the calculation result value of the Chebyshev polynomial from the key generation center KGC.

Meanwhile, after successfully the User registering Equipment UEᵢ, the key generation center KGC calculates a first hash function H₁ using the calculation result value of the Chebyshev polynomial. Then, the key generation center KGC uses the calculation value of the first hash function and the ID of the User Equipment to perform the following concatenation operation.

$${H}_{1} ( {T}_{{k}_{i}} ( I {D}_{{UE}_{i}} ⊕ {k}_{i} ) mod q ) \vert \vert {ID}_{{UE}_{i}}$$

Moreover, the key generation center KGC then sends the result value of the concatenation operation to the Serving Network SNⱼ.

### Registration of Machine-Type Communication Device

The machine-type communication device MD registers its information with the key generation center KGC.

Before registering the machine-type communication device MD, the massive machine-type communication devices mMTC are grouped according to specific requirements. An MTC group leader is selected by the key generation center KGC based on comprehensive capabilities.

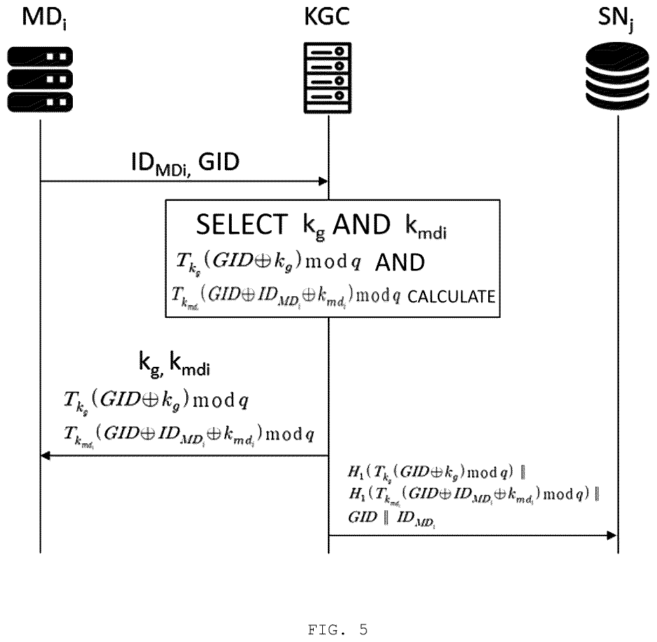

FIG. 5 is a reference diagram for the machine-type communication device registering its information with the key generation center.

Referring to FIG. 5, first, the machine-type communication device MDᵢ sends its ID ID_{MDi} and the leader ID GID of the group to which the machine-type communication device belongs to the key generation center KGC.

Next, the key generation center KGC selects a private key k_{g} of the group leader and a private key k_{mdi} of the machine-type communication device MDᵢ. Using the ID GID of the group leader, the private key k_{g} of the group leader, and the ID ID_{MDi} and private key k_{mdi} of the machine-type communication device, the key generation center KGC calculates the following two Chebyshev polynomials.

$${T}_{{k}_{g}} ( GID ⊕ {k}_{g} ) mod q$$

$${T}_{{k}_{{md}_{i}}} ( GID ⊕ {ID}_{{MD}_{i}} ⊕ {k}_{{md}_{i}} ) mod q$$

Moreover, the machine-type communication device MDᵢ receives the private key k_{g} of the group leader, the private key k_{mdi}, and the calculation results of the two Chebyshev polynomials from the key generation center KGC.

Meanwhile, after successfully registering the machine-type communication device MDᵢ, the key generation center KGC calculates the first hash function H₁ using the calculation result values of the two Chebyshev polynomials. Then, the key generation center KGC performs the following operation using the calculation values of the two first hash functions, the ID ID_{MDi} of the machine-type communication device MDᵢ, and the leader ID GID of the group.

$${H}_{1} ( {T}_{{k}_{j}} ( GID ⊕ {k}_{g} ) mod q ) ‖ {H}_{1} ( {T}_{{k}_{md}} ( GID ⊕ {ID}_{{MD}_{i}} ⊕ {k}_{{md}_{i}} ) mod q ) \vert \vert GID ‖ {ID}_{{MD}_{i}}$$

Moreover, the key generation center KGC sends the result value of the operation to the serving network SNⱼ.

### <Authentication and Key Agreement Step>

### User Equipment Authentication

The User Equipment UEᵢ requests authentication from the serving network SN, and the serving network SN responds to the authentication request.

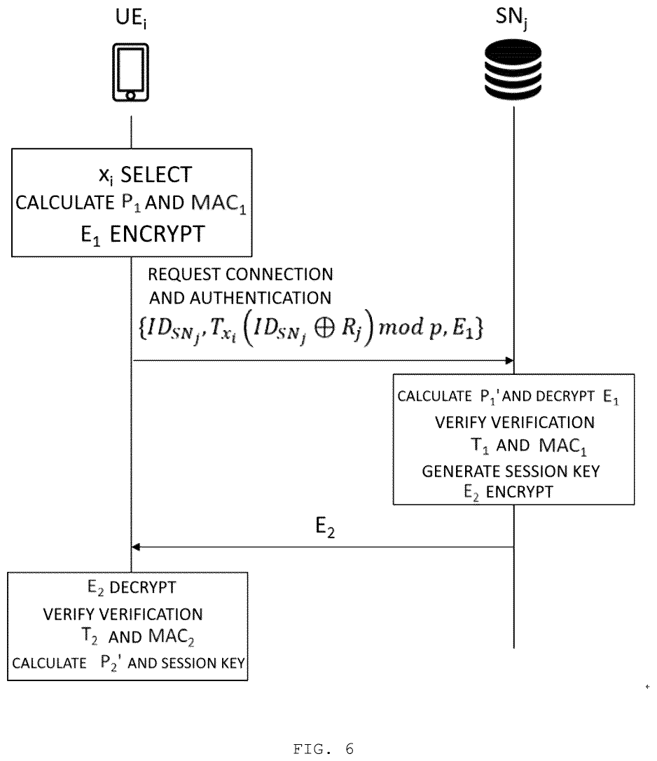

FIG. 6 is a reference diagram for an authentication procedure between the User Equipment and the serving network.

Referring to FIG. 6, the User Equipment UEᵢ first selects a random number xᵢ and calculates the two Chebyshev polynomials below.

$${T}_{{x}_{i}} ( {ID}_{{SN}_{j}} ⊕ {ID}_{{UE}_{i}} ) mod q$$

$${T}_{{x}_{i}} ( {ID}_{{UE}_{i}} ⊕ {R}_{j} ) mod q$$

The User Equipment UEᵢ then calculates P₁ and the first authentication code message MAC₁ according to the Expression below.

$${P}_{1} = {T}_{{x}_{i}} ( {T}_{{k}_{i}} ( {ID}_{{SN}_{j}} ⊕ {R}_{j} ) mod q ) mod q$$

$${MAC}_{1} = {H}_{1} ( {P}_{1} , {ID}_{{UE}_{i}} , {ID}_{{SN}_{j}} , {T}_{{x}_{i}} ( {ID}_{{SN}_{j}} ⊕ {ID}_{{UE}_{i}} ) mod q , {T}_{{x}_{i}} ( {ID}_{{UE}_{i}} ⊕ {k}_{i} ) mod q )$$

The User terminal UEᵢ then uses P₁ to generate the first encrypted data E₁ as follows.

$${E}_{1} = {ENC}_{{P}_{1}} ( {ID}_{{UE}_{i}} ‖ {T}_{{x}_{i}} ( {ID}_{{SN}_{j}} ⊕ {ID}_{{UE}_{i}} ) mod q ‖$$

$${T}_{{x}_{i}} ( {ID}_{{UE}_{i}} ⊕ {k}_{i} ) mod q ‖ {T}_{{k}_{j}} ( {ID}_{{SN}_{j}} ⊕ {R}_{j} ) mod q \vert \vert {MAC}_{1} ‖ {T}_{1} )$$

Then, the User Equipment UEᵢ sending the ID ID_{SNj} of the serving network, the first encrypted data E₁, and the value of T_{z}_{ᵢ}(ID_{SN}_{ⱼ}⊕Rⱼ)mod q along with the authentication request to the serving network SNⱼ.

The serving network SNⱼ receives the authentication request from the User Equipment UEᵢ and calculates P₁′ according to the following Expression.

$${P}_{1}^{′} = {T}_{{k}_{j}} ( {T}_{{x}_{i}} ( {ID}_{{SN}_{j}} ⊕ {R}_{j} ) mod q ) mod q$$

Moreover, the serving network SNⱼ decrypts SNⱼ the first encrypted data E) using P₁′ to obtain the ID ID_{UEi} of the User Equipment, the first authentication code message MAC₁, Tₓ_{ᵢ}(ID_{SN}_{ᵢ}⊕ID_{UE}_{ᵢ})mod q, T_{z}_{ᵢ}(ID_{UE}_{ᵢ}⊕kᵢ)mod q, Tₖ_{ᵢ}(ID_{SN}_{ᵢ}⊕Rⱼ)mod q), and the first timestamp T₁.

In addition, the serving network SNⱼ verifies whether the ID ID_{UEi} of the User Equipment exists in the database of the serving network SNⱼ using the Expression below.

$${H}_{1} ( {T}_{{x}_{i}} ( {ID}_{{UE}_{i}} ⊕ {k}_{i} ) mod q )$$

When the ID of the User Equipment does not exist in the database, the serving network SNⱼ sends an authentication failure message to the User Equipment UEi. On the other hand, when the ID of the User Equipment exists in the database, the serving network SNⱼ proceeds to the Next step.

The serving network SNⱼ uses Tₓ_{ᵢ}(ID_{UE}_{ᵢ}⊕kdᵢ)mod q to verify the validity of the first authentication code message MAC₁. Additionally, the serving network SNi verifies whether the first timestamp T₁ is valid. When the first timestamp is invalid, the serving network SNⱼ sends the authentication failure message to the User Equipment UEᵢ. When the first timestamp is valid, the serving network SNⱼ proceeds to the next step.

The serving network SNⱼ then selects a random number yⱼ and calculates the following Expression.

$${T}_{{y}_{j}} ( {ID}_{{SN}_{j}} ⊕ {ID}_{{UE}_{i}} ) mod q$$

The serving network SNⱼ then calculates P₂ according to the following Expression.

$${P}_{2} = {T}_{{k}_{i}} ( {T}_{{x}_{i}} ( {ID}_{{UE}_{i}} ⊕ {R}_{j} ) mod q ) mod q$$

The serving network SNⱼ then generates the session key SK_{UEi} according to the following Expression.

$${SK}_{{UE}_{i}} = {H}_{2} ( {T}_{{y}_{i}} ( {{T}_{x}}_{i} ( {ID}_{{SN}_{j}} ⊕ {ID}_{{UE}_{i}} ) mod q ) mod q )$$

The serving network SNⱼ then calculates the second authentication code message MAC₂ according to the following Expression.

$${MAC}_{2} = {H}_{1} ( {P}_{1}^{′} , {P}_{2} , {ID}_{{UE}_{i}} , {ID}_{{SN}_{j}} , {T}_{{k}_{j}} ( {ID}_{{UE}_{i}} ⊕ {R}_{j} ) mod q ,$$

$${T}_{{k}_{i}} ( {ID}_{{UE}_{i}} ⊕ {k}_{i} ) mod q , {T}_{{y}_{i}} ( {ID}_{{SN}_{j}} ⊕ {ID}_{{UE}_{i}} ) mod q , {SK}_{{UE}_{i}} )$$

The serving network SNⱼ then generates the second encrypted data E₂ using the P₁.

$${E}_{2} = {ENC}_{{P}_{1}}^{′} ( {T}_{{y}_{i}} ( {ID}_{{SN}_{j}} ⊕ {ID}_{{UE}_{i}} ) mod q \vert \vert$$

$${T}_{{k}_{j}} ( {ID}_{{UE}_{i}} ⊕ {R}_{j} ) mod q ‖ {MAC}_{2} ‖ {T}_{2} )$$

The serving network SNⱼ then sends the E₂ to the User Equipment UEᵢ.

The User Equipment UEᵢ verifies the session key. First, the User Equipment UEᵢ decrypts the second encrypted data E₂ to obtain T_{y}_{ᵢ}(ID_{SN}_{ⱼ}⊕ID_{UE}_{ᵢ})mod q, Tₖ_{ⱼ}(ID_{UE}_{ᵢ}⊕Rⱼ)mod q, the second authentication code message MAC₂, and the second timestamp T₂.

The User Equipment UEᵢ then calculates P₂′ according to the following Expression.

$${P}_{2}^{′} = {T}_{{x}_{i}} ( {T}_{{k}_{j}} ( {ID}_{{UE}_{i}} ⊕ {R}_{j} ) mod q ) mod q$$

Moreover, the User Equipment UEᵢ calculates the session key SK_{UEi} according to the Expression below.

$${SK}_{{UE}_{i}} = {H}_{2} ( {T}_{{x}_{j}} ( {T}_{{y}_{i}} ( {ID}_{{SN}_{j}} ⊕ {ID}_{{UE}_{i}} ) mod q ) mod q )$$

The User Equipment UEᵢ then verifies whether the second timestamp T₂ and the second authentication code massage MAC₂ are valid. When the second timestamp and the second authentication code message are valid, the authentication between the User Equipment UEᵢ and the serving network SNⱼ is successful. If not, the User Equipment UEᵢ sends an authentication failure message to the serving network SNⱼ.

### Authentication of Massive Machine-Type Communication Device

Each machine-type communication device MDᵢ requests authentication from the serving network SN through the group leader MDₙ, and the serving network SN responds to the authentication request.

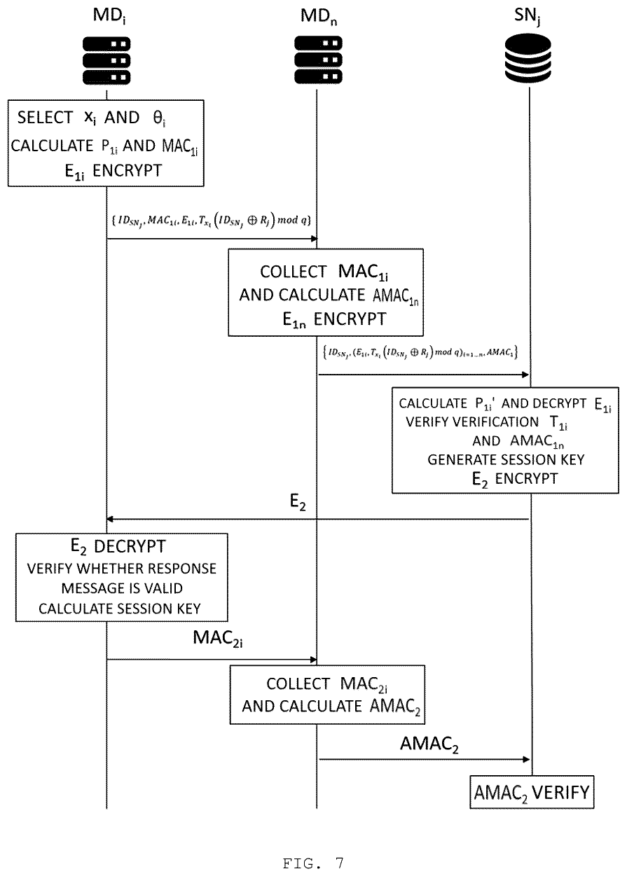

FIG. 7 is a reference diagram for the authentication procedure between the massive machine-type communication device and the serving network.

Referring to FIG. 7, the machine-type communication device MDᵢ first sends its information to the group leader. The machine-type communication device MDᵢ selects two random numbers xᵢ and θᵢ and calculates P₁ᵢ according to the following Expression.

$${P}_{1 i} = {T}_{{x}_{i}} ( {T}_{{k}_{j}} ( {ID}_{{SN}_{j}} ⊕ {R}_{j} ) mod q ) mod q$$

Moreover, the machine-type communication device MDᵢ calculates the 1ᵢ authentication code message MAC₁ᵢ according to the Expression below.

$${MAC}_{1 i} = {H}_{1} ( {P}_{1} , {ID}_{{SN}_{i}} , {ID}_{{MD}_{i}} , GID , {T}_{{k}_{{md}_{i}}} ( GID ⊕ {ID}_{{MD}_{i}} ⊕ {k}_{{md}_{i}} ) mod q , {T}_{{x}_{i}} ( {ID}_{{MD}_{i}} ⊕ {R}_{j} ) mod q , {T}_{{x}_{i}} ( {ID}_{{SN}_{j}} ⊕ {ID}_{{MD}_{i}} ) mod q , {θ}_{i} )$$

Further, the machine-type communication device MDᵢ uses P₁ᵢ to generate the 1ᵢ encrypted data E₁ᵢ as follows.

$${E}_{1 i} = {ENC}_{{P}_{1 i}} ( {ID}_{{MD}_{i}} ‖ {T}_{{x}_{i}} ( {ID}_{{SN}_{i}} ⊕ {ID}_{{MD}_{i}} ⊕ GID ) mod q ‖ {T}_{{k}_{{md}_{i}}} ( GID ⊕ {ID}_{{MD}_{i}} ⊕ {k}_{{md}_{i}} ) mod q ‖ {T}_{{x}_{j}} ( {ID}_{{SN}_{j}} ⊕ {R}_{j} ) mod q ) ‖ {T}_{1 i} ‖ {θ}_{i} )$$

Then, the machine-type communication device MDᵢ sends the ID ID_{SNj} of the serving network, the 1ᵢ authentication code message MAC₁ᵢ, the 1ᵢ encrypted data E₁ᵢ and the value of Tₓ_{ᵢ}(ID_{SN}_{ⱼ}⊕Rⱼ)mod q to the group leader MDₙ.

The group leader MDₙ uses information received from the machine-type communication devices MDᵢ belonging to the group to send an aggregate authentication request message to the serving network SNⱼ. The group leader MDₙ collects the 1ᵢ authentication code messages MAC₁ᵢ from the machine-type communication devices MDᵢ belonging to the group and calculates the first aggregate authentication code message AMAC₁ according to the following Expression.

$${AMAC}_{1} = {⊕}_{i = 1}^{n} {MAC}_{1 i}$$

Moreover, the group leader MDₙ uses P₁ₙ to generate the 1ₙ encrypted data E₁ₙ as follows.

$${E}_{1 n} = {ENC}_{{P}_{1 n}} ( GID ‖ {ID}_{{MD}_{n}} ‖ {T}_{{x}_{n}} ( {ID}_{{SN}_{j}} ⊕ {ID}_{{MD}_{n}} ⊕ GID ) mod q ‖ {T}_{{k}_{{md}_{n}}} GID ⊕ {ID}_{{MD}_{n}} ⊕ {k}_{{md}_{n}} ) mod q ‖ {T}_{{k}_{g}} ( GID ⊕ {k}_{g} ) mod q ‖ {T}_{{k}_{g}} ( {ID}_{{SN}_{j}} ⊕ GID ⊕ {R}_{j} ) mod q ‖ {T}_{{x}_{n}} ( {ID}_{{SN}_{j}} ⊕ {R}_{j} ) mod q ‖ {T}_{1 n} ‖ {θ}_{n} ‖ {AMAC}_{1} )$$

Then, the group leader MDₙ sends the ID ID_{SNj} of the serving network, the 1ᵢ to 1ₙ encrypted data E₁₁ to E₁ₙ, (Tₓ_{ᵢ}(ID_{SN}_{ᵢ}⊕Rⱼ)mod q__{i=1, . . . n}, and the value of the first aggregate authentication code message AMAC₁ along with the authentication request to the serving network SNⱼ.

The serving network SNⱼ verifies the validity of the aggregate authentication message received from the group leader MDₙ. The serving network SNⱼ calculates P₁′ according to the following Expression.

$${P}_{1 i}^{′} = {T}_{{k}_{j}} ( {T}_{{x}_{i}} ( {ID}_{{SN}_{j}} ⊕ {R}_{j} ) mod q ) mod q$$

Moreover, the serving network SNⱼ decrypts the 1ᵢ to 1ₙ encrypted data E₁₁ to E₁ₙ using P₁′.

Further, the serving network SNⱼ uses P₁ᵢ to verify whether the 1ᵢ timestamp T₁ᵢ and the first aggregate authentication code message AMAC₁ are valid. When the 1ᵢ timestamp and the first aggregate authentication code message are invalid, the serving network SNⱼ sends an authentication failure message to the machine-type communication device MDᵢ. When the 1ᵢ timestamp and the first aggregate authentication code message are valid, the serving network SNⱼ proceeds to the Next step.

Moreover, the serving network SNⱼ verifies whether the machine-type communication device MDᵢ is in the database of the serving network SNⱼ using the following Expression and the group ID GID and the ID ID_{MDi} of the machine-type communication device.

$$\begin{matrix}{T}_{{k}_{{md}_{i}}} ( GID ⊕ {ID}_{{MD}_{i}} ⊕ {k}_{{md}_{i}} ) mod q \\ {T}_{{k}_{g}} ( GID ⊕ {k}_{g} ) mod q\end{matrix}$$

When the machine-type communication device does not exist in the database, the serving network SNⱼ sends the authentication failure message to the machine-type communication device MDᵢ. On the other hand, when the machine-type communication device does exist in the database, the serving network SNⱼ verifies the aggregate authentication request message as valid and proceeds to the next step.

The serving network SNⱼ calculates P₂ according to the Expression below.

$${P}_{2} = {T}_{{k}_{j}} ( {T}_{kg} ( {ID}_{{SN}_{j}} ⊕ GID ⊕ {R}_{j} ) mod q ) mod q$$

Moreover, the serving network SNⱼ may obtain the following values using Chinese Remainder Theorem (CRT).

$$Θ = {\prod }_{i = 1}^{n} {θ}_{i} , {Θ}_{i} = Θ / {θ}_{i} , {c}_{i} = {Θ}_{i}^{- 1}$$

Further, the serving network SNⱼ may obtain the S value according to the Expression below.

$$S = ( {\sum }_{i = 1}^{n} {H}_{2} ( {ID}_{{MD}_{i}} , GID , {ID}_{{SN}_{j}} , {P}_{1 i}^{′} , {P}_{2} ) {c}_{i} {Θ}_{i} ) mod Θ$$

In addition, the serving network SNⱼ calculates the session key SKMDᵢ and the serving network authentication code message MAC_{SN} according to the Expression below.

$${SK}_{{MD}_{i}} = {H}_{2} ( {T}_{{y}_{i}} ( {T}_{{x}_{i}} ( {ID}_{{SN}_{i}} ⊕ {ID}_{{MD}_{i}} ⊕ GID ) mod q ) mod q , {ID}_{{SN}_{j}} , {ID}_{{MD}_{i}} , GID , {θ}_{i} )$$

$${MAC}_{SN} = {H}_{1} ( {P}_{2} , S , GID , {ID}_{{SN}_{j}} )$$

Then, the serving network SNⱼ generates the second encrypted data E₂ using P₁ᵢ and broadcasts the second encrypted data to the machine-type communication device MDᵢ.

$${E}_{2} = {ENC}_{{P}_{1 i}^{′}} ( {T}_{{k}_{i}} ( {ID}_{{SN}_{j}} ⊕ GID ⊕ {R}_{j} ) mod q , {T}_{{y}_{j}} ( {ID}_{{SN}_{j}} ⊕ {ID}_{{MD}_{i}} , GID ) mod q , S , {MAC}_{SN} , {T}_{2} )$$

Moreover, the serving network SNⱼ broadcasts the second encrypted data E₂ to the machine-type communication device MDᵢ.

The machine-type communication device MDᵢ verifies the session key. First, each machine-type communication device MDᵢ decrypts the second encrypted data E₂ using P₁ to obtain the second authentication code message MAC_{SN}, Tₖ_{ᵢ}(ID_{SN}_{ⱼ}⊕GID⊕Rⱼ)mod q, T_{y}_{ⱼ}(ID_{SN}_{ⱼ}⊕ID_{MD}_{ᵢ},GID)mod q, and the second time stamp T₂.

Moreover, the machine-type communication device MDᵢ verifies whether the serving network authentication code message MAC_{SN} and the second time stamp T₂ are valid. When the serving network authentication code message and the second time stamp are invalid, the machine-type communication device MDᵢ sends the authentication failure message to the serving network SNⱼ. When the serving network authentication code message and the second time stamp are valid, the machine-type communication device MDᵢ proceeds to the next step.

The machine-type communication device MDᵢ verifies that the following Expression is correct.

$${H}_{2} ( {ID}_{{MD}_{i}} , GID , {ID}_{{SN}_{i}} , {P}_{1 i} , {P}_{2}^{′} ) = S mod {θ}_{i}$$

When the Expression is incorrect, the machine-type communication device MDᵢ sends the authentication failure message to the serving network SNⱼ. When the Expression is correct, the machine-type communication device MDᵢ proceeds the next step.

The machine-type communication device MDᵢ calculates the session key SK′MDᵢ according to the Expression below.

$${SK}_{{MD}_{i}}^{′} = {H}_{2} ( {T}_{{x}_{i}} ( {T}_{{y}_{i}} ( {ID}_{{SN}_{j}} ⊕ {ID}_{{MD}_{i}} ⊕ GID ) mod q ) mod q , {ID}_{{SN}_{j}} , {ID}_{{MD}_{i}} , GID , {θ}_{i} )$$

Moreover, the machine-type communication device MDᵢ calculates the 2ᵢ authentication code message MAC₂ᵢ according to the Expression below.

$${MAC}_{2 i} = {H}_{1} ( {SK}_{{MD}_{i}}^{′} , {ID}_{{SN}_{j}} , {ID}_{{MD}_{i}} , GID , {T}_{{y}_{i}} , ( {ID}_{{SN}_{j}} ⊕ {ID}_{{MD}_{i}} ⊕ GID ) mod q , {T}_{{x}_{i}} ( {ID}_{{SN}_{j}} ⊕ {ID}_{{MD}_{i}} ⊕ GID ) mod q )$$

Further, the machine-type communication device MDᵢ sends the 2ᵢ authentication code message MAC₂₁ to the group leader MDₙ.

The group leader MDₙ and the serving network SNⱼ verify the validity of the aggregate authentication. The group leader MDₙ collects the 2ᵢ authentication code messages MAC₂ᵢ from the machine-type communication devices MDᵢ belonging to the group and calculates the second aggregate authentication code message AMAC₂ according to the following Expression.

$${AMAC}_{2} = {⊕}_{i = 1}^{n} {MAC}_{2 i}$$

Then, the group leader MDₙ sends the second aggregate authentication code message AMAC₂ to the serving network SNⱼ.

The serving network SNⱼ verifies the validity of the second aggregate authentication code message AMAC₂. When the second aggregate authentication code message is valid, authentication between the massive machine-type communication devices MD₁ to MDₙ and the serving network SNⱼ is successful. When the second aggregate authentication code message is invalid, the serving network SNⱼ sends a failure message to the machine-type communication device MDᵢ.

The access authentication method described herein is a lightweight, secure authentication method utilizing the extended Chebyshev chaotic map, and significantly improves security and performance compared to the existing 5G-AKA protocol and the latest protocols. The access authentication method enhances security by reducing signal congestion, reducing computation and storage costs, ensuring mutual authentication and identity anonymity, and preventing replay attacks, man-in-the-middle attacks, and enhancing PFS/PBS security. Furthermore, the group leader concept reduces the authentication signal volume of MTC devices. Therefore, the access authentication method described herein may be utilized as an efficient authentication system not only in 5G environments but also in various fields such as IoT, smart factories, and autonomous driving.

The advantages and features of the disclosure disclosed in the present disclosure, and the methods for achieving them, will become clearer with reference to the embodiments described in detail below together with the accompanying drawings. However, the present disclosure is not limited to the embodiments disclosed below and may be implemented in various different forms. These embodiments are provided only to ensure that the disclosure of the present disclosure is complete and to fully inform those of ordinary skill in the art (hereinafter referred to as “skilled workers”) of the scope of the present disclosure, and the scope of rights of the present disclosure is defined only by the scope of the claims.

The terminology used in the present disclosure is for the purpose of describing embodiments and is not intended to limit the scope of the present disclosure. In the present disclosure, singular forms also include plural forms, unless specifically stated otherwise. As used in the present disclosure, the terms “comprise” and/or “comprising” do not exclude the presence or addition of one or more other components in addition to the components mentioned.

Throughout the specification, the same reference numerals refer to the same elements, and the term “and/or” includes each and every combination of the elements mentioned. Although terms such as “first”, “second”, or the like are used to describe various elements, these elements are not limited by these terms. These terms are used only to distinguish one element from another. Therefore, it should be understood that a first element mentioned below may also be a second element within the technical scope of the present disclosure.

Unless otherwise defined, all terms (including technical and scientific terms) used in the present disclosure may be used in their common sense to those skilled in the art to which the present disclosure pertains. Furthermore, terms defined in commonly used dictionaries are not to be interpreted ideally or excessively unless explicitly and specifically defined otherwise.

The above-described key generation center, serving network, User Equipment, and machine-type communication device may include a hardware processor, an application-specific integrated circuit (ASIC), other chipsets, logic circuits, registers, communication modems, data processing devices, or the like known in the technical field to which the present disclosure pertains to execute calculations and various control logics. In addition, when the the above-described control logic is implemented in software, control unit may be implemented as a set of program modules. In this case, the program modules may be stored in the memory device and executed by the processor.

The above-described computer program may include codes coded in a computer language, such as C/C++, C#, JAVA, Python, or machine language, that may be read by the processor CPU of the computer through the device interface of the computer, so that the computer reads the program and executes the methods implemented as a program. Such codes may include functional codes related to functions that define functions necessary for executing the methods, and may include control codes related to execution procedures necessary for the processor of the computer to execute the functions according to a predetermined procedure. In addition, such codes may further include memory reference-related codes regarding which location (address address) of the internal or external memory of the computer should reference additional information or media necessary for the processor of the computer to execute the functions. In addition, if the processor of the computer needs to communicate with any other computer or server located remotely in order to execute the functions, the code may further include communication-related code regarding how to communicate with any other computer or server located remotely using the communication module of the computer, and what information or media to send and receive during communication.

The above storage medium refers to a medium that stores data semi-permanently and may be read by a device, rather than a medium that stores data for a short period of time, such as a register, cache, or memory. Specifically, examples of the storage medium include, but are not limited to, ROM, RAM, CD-ROM, magnetic tape, floppy disk, and optical data storage device. That is, the program may be stored in various recording media on various servers that the computer may access or in various recording media on the user's computer. In addition, the medium may be distributed across network-connected computer systems, so that computer-readable code may be stored in a distributed manner.

Although the embodiments of the present disclosure have been described with reference to the attached drawings, those skilled in the art will appreciate that the present disclosure may be implemented in other specific forms without altering the technical spirit or essential features thereof. Therefore, the embodiments described above should be understood to be illustrative in all respects and not restrictive.

What is claimed is:

1. A registration method for access authentication in a 5G network, including a serving network, a key generation center, and a User Equipment, the registration method comprising:
(a) receiving an ID from the serving network or the User Equipment and selecting an encryption key by means of the key generation center;
(b) calculating a Chebyshev polynomial using the ID and the encryption key by means of the key generation center; and
(c) transmitting a result value of the Chebyshev polynomial calculated in the (b) and the encryption key to the serving network or the User Equipment by means of the key generation center.

2. The registration method according to claim 1, wherein in the (a), the key generation center selects a private key and a public key when receiving the ID from the serving network,
in the (b), the key generation center calculates the Chebyshev polynomial using the ID and the public key from the serving network, and
in the (c), the key generation center transmits the result value of the Chebyshev polynomial calculated in the (b), the private key, and public key to the serving network.

3. The registration method according to claim 2, wherein in the step (b), the key generation center calculates the Chebyshev polynomial according to the following Expression:
$${T}_{{k}_{j}} ( {ID}_{{SN}_{j}} ⊕ {R}_{j} ) mod q$$
where, ID_{SNj} is ID of the serving network,
Rⱼ is the public key,
q is a prime number,
Tₐ(P) mod q is an extended Chebyshev polynomial, and
⊕ is Bitwise XOR operation.

4. The registration method according to claim 1, wherein in the (a), the key generation center selects a private key when receiving the ID from the User Equipment,
in the (b), the key generation center calculates the Chebyshev polynomial using the ID and the private key from the serving network, and
in the (c), the key generation center transmits the result value of the Chebyshev polynomial calculated in the (b) and the private key to the User Equipment.

5. The registration method according to claim 4, wherein in step (b), the key generation center calculates the Chebyshev polynomial according to the following Expression:
$${T}_{{k}_{i}} ( {ID}_{{UE}_{i}} ⊕ {k}_{i} ) mod q$$
where, ID_{UEi} is ID of the User Equipment,
kᵢ is the private key,
q is a prime number,
Tₐ(P) mod q is an extended Chebyshev polynomial, and
⊕ is Bitwise XOR operation.

6. The registration method according to claim 4, further comprising: (d) calculating a first hash function using the result value of the Chebyshev polynomial calculated in the (b) and transmitting a value obtained by concatenating a calculation value of the first hash function and the ID of the User Equipment to the serving network by means of the key generation center.

7. An access authentication method between the serving network and the User Equipment that performs the registration method according to claim 1, the access authentication method comprising:
(a) calculating the Chebyshev polynomial using a random number (xᵢ) and sending an authentication request message including the calculation value of the Chebyshev polynomial to the serving network by means of the User Equipment;
(b) verifying validity of the authentication request message received from the User Equipment by means of the serving network;
(c) calculating the Chebyshev polynomial using a random number (y) when the authentication request message is valid, generating a session key using the calculation value of the Chebyshev polynomial, and sending the session key to the User Equipment by means of the serving network; and
(d) verifying the validity of the session key by means of the User Equipment.

8. The access authentication method according to claim 7, wherein the (a) includes
(a-1) selecting the random number (xᵢ) and calculating the two Chebyshev polynomials below by means of the User Equipment,
$${T}_{{x}_{i}} ( {ID}_{{SN}_{j}} ⊕ {ID}_{{UE}_{i}} ) mod q$$
$${T}_{{x}_{i}} ( {ID}_{{UE}_{i}} ⊕ {R}_{j} ) mod q$$
(a-2) calculating P₁ and a first authentication code message (MAC₁) according to the following Expression by means of the User Equipment
$${P}_{1} = {T}_{{x}_{i}} ( {T}_{{k}_{i}} ( {ID}_{{SN}_{j}} ⊕ {R}_{j} ) mod q ) mod q$$
$${MAC}_{1} = {H}_{1} ( {P}_{1} , {ID}_{{UE}_{i}} , {ID}_{{SN}_{i}} , {T}_{{x}_{i}} ( {ID}_{{SN}_{i}} ⊕ {ID}_{{UE}_{i}} ) mod q , {T}_{{x}_{i}} ( {ID}_{{UE}_{i}} ⊕ {k}_{i} ) mod q ) ,$$
(a-3) generating first encrypted data (E₁) using P₁ as follows by means of the User Equipment, and
$${E}_{1} = {ENC}_{{P}_{1}} ( {ID}_{{UE}_{i}} ‖ {T}_{{x}_{i}} ( {ID}_{{SN}_{i}} ⊕ {ID}_{{UE}_{i}} ) mod q ‖ {T}_{{x}_{i}} ( {ID}_{{UE}_{i}} ⊕ {k}_{i} ) mod q ‖ {T}_{{k}_{j}} ( {ID}_{{SN}_{j}} ⊕ {R}_{j} ) mod q ‖ {MAC}_{1} ‖ {T}_{1} )$$
(a-4) sending an ID (ID_{SNj}) of the serving network, the first encrypted data (E₁), and a value of Tₓ_{ᵢ}(ID_{SN}_{ⱼ}⊕Rⱼ)mod q along with an authentication request to a serving network (SNⱼ) by means of the User Equipment.

9. The access authentication method according to claim 8, wherein the (b) includes
(b-1) receiving the authentication request from the User Equipment and calculating P₁′ according to the following Expression by means of the serving network,
$${P}_{1}^{′} = {T}_{{k}_{j}} ( {T}_{{x}_{i}} ( {ID}_{{SN}_{j}} ⊕ {R}_{j} ) mod q ) mod q$$
(b-2) decrypting the first encrypted data (E₁) using P₁′ to obtain the ID (ID_{UEi}) of the User Equipment, Tₓ_{ᵢ}(ID_{SN}_{ⱼ}⊕ID_{UE}_{ᵢ})mod q, a first authentication code message (MAC₁), Tₓ_{ᵢ}(ID_{UE}_{ᵢ}⊕kᵢ)mod q, Tₖ_{ⱼ}(ID_{SN}_{ⱼ}⊕Rⱼ)mod q), and a first timestamp (T₁) by means of the serving network,
(b-3) verifying whether the User Equipment's ID exists in a serving network's database using the following Expression by means of the serving network
$${H}_{1} ( {T}_{{x}_{i}} ( {ID}_{{UE}_{i}} ⊕ {k}_{i} ) mod q ) ,$$
and
(b-4) verifying whether the first authentication code message (MAC₁) and the first timestamp (T₁) are valid using Tₓ_{ᵢ}(ID_{UE}_{ᵢ}⊕kᵢ)mod q by means of the serving network when the User Equipment's ID exists in the serving network's database.

10. The access authentication method according to claim 7, wherein the (c) includes
(c-1) selecting a random number (yⱼ) and calculating the 2 Expression below by means of the serving network,
$${T}_{{y}_{i}} ( {ID}_{{SN}_{j}} ⊕ {ID}_{{UE}_{i}} ) mod q$$
$${T}_{{k}_{j}} ( {T}_{{x}_{i}} ( {ID}_{{UE}_{I}} ⊕ {R}_{j} ) mod q ) mod q$$
(c-2) calculating P₂ according to the Expression below by means of the serving network,
$${P}_{2} = {T}_{{k}_{i}} ( {T}_{{x}_{i}} ( {ID}_{{UE}_{i}} ⊕ {R}_{j} ) mod q ) mod q$$
(c-3) generating a session key (SK_{UEi}) according to the Expression below by means of the serving network,
$${SK}_{{UE}_{i}} = {H}_{2} ( {T}_{{y}_{i}} ( {T}_{{x}_{i}} ( {ID}_{{SN}_{i}} ⊕ {ID}_{{UE}_{i}} ) mod q ) mod q )$$
(c-4) calculating a second authentication code message (MAC₂) according to the Expression below by means of the serving network,
$${MAC}_{2} = {H}_{1} ( {P}_{1}^{′} , {P}_{2} , {ID}_{{UE}_{i}} , {ID}_{{SN}_{j}} {T}_{{k}_{j}} ( {ID}_{{UE}_{i}} ⊕ {R}_{j} ) mod q , {T}_{{K}_{i}} ( {ID}_{{UE}_{i}} {k}_{i} ) mod q , {T}_{{y}_{i}} ( {ID}_{{SN}_{j}} ⊕ {ID}_{{UE}_{i}} ) mod q , {SK}_{{UE}_{i}} )$$
(c-5) generating second encrypted data (E₂) using the P₁ by means of the serving network, and
$${E}_{2} = {ENC}_{{P}_{1}}^{′} ( {T}_{{y}_{j}} ( {ID}_{{SN}_{j}} ⊕ {ID}_{{UE}_{i}} ) mod q ‖ {T}_{{k}_{j}} ( {ID}_{{UE}_{i}} ⊕ {R}_{j} ) mod q ‖ {MAC}_{2} ‖ {T}_{2} )$$
(c-6) sending the second encrypted data (E₂) to the User Equipment by means of the serving network.

11. The access authentication method according to claim 10, wherein the (d) includes
(d-1) decrypting the second encrypted data (E₂) to obtain T_{y}_{ⱼ}(ID_{SN}_{ⱼ}⊕ID_{UE}_{ᵢ})mod q, Tₖ_{ⱼ}(ID_{UE}_{ᵢ}⊕Rⱼ)mod q, a second authentication code message (MAC₂), and a second timestamp (T₂) by means of the User Equipment,
(d-2) calculating P₂′ according to the following Expression by means of the User Equipment
$${P}_{2}^{′} = {T}_{{x}_{i}} ( {T}_{{k}_{j}} ( {ID}_{{UE}_{i}} ⊕ {R}_{j} ) mod q ) mod q ,$$
(d-3) calculating a session key (SK_{UEi}) according to the following Expression by means of the User Equipment
$${SK}_{{UE}_{i}} = {H}_{2} ( {T}_{{x}_{i}} ( {T}_{{y}_{i}} ( {ID}_{{SN}_{j}} ⊕ {ID}_{{UE}_{i}} ) mod q ) mod q ) ,$$
and
(d-4) verifying whether the second timestamp (T₂) and the second authentication code message (MAC₂) are valid by means of the User Equipment.

12. A registration method for access authentication in a 5G network including a serving network, a key generation center, and n machine-type communication devices grouped together, the registration method comprising:
(a) receiving IDs from the n machine-type communication devices and selecting an encryption key by means of the key generation center;
(b) calculating a Chebyshev polynomial using the IDs and the encryption key by means of the key generation center;
(c) transmitting a result value of the Chebyshev polynomials calculated in the (b) and the encryption key to the n machine-type communication devices by means of the key generation center; and
(d) transmitting information about the n machine-type communication devices to the serving network by means of the key generation center.

13. The registration method according to claim 12, wherein in the (a), when the key generation center receives an ID from a machine-type communication device belonging to the group, the key generation center receives its own ID and a leader ID of the group to which the key generation center belongs.

14. The registration method according to claim 12, wherein in the (a), the key generation center selects a private key of the group leader and a private kye of the machine-type communication device, and
in the (b), the key generation center calculates the following two Chebyshev polynomials using the ID of the group leader and the private key of the group leader, and the ID and the private key of the machine-type communication device:
$${T}_{{k}_{g}} ( GID ⊕ {k}_{g} ) mod q$$
$${T}_{{k}_{mdi}} ( GID ⊕ {ID}_{{MD}_{i}} ⊕ {k}_{{md}_{i}} ) mod q$$
where, GID is the ID of the group leader,
k_{g} is the private key of the group leader,
ID_{MDi} is the ID of the machine-type communication device,
K_{mdi} is the private key of the machine-type communication device,
q is a prime number,
Tₐ(P) mod q is an extended Chebyshev polynomial, and
⊕ is Bitwise XOR operation.

15. The registration method according to claim 12, wherein in the (d), the key generation center calculates a first hash function (H₁) using calculation result values of the two Chebyshev polynomials calculated in the (b), and transmits a value obtained by concatenating the calculation values of the two first hash functions with the ID (ID_{MDi}) of a machine-type communication device (MDᵢ) and the ID (GID) of the group leader to the serving network.

16. An access authentication method between the n machine-type communication devices and the serving network that perform the registration method according to claim 12, the access authentication method comprising:
(a) sending its own information to a group leader by means of the machine-type communication device;
(b) sending an aggregate authentication request message to the serving network using information received from the machine-type communication device belonging to the group by means of the group leader;
(c) verifying validity of the aggregate authentication request message received from the group leader by means of the serving network;
(d) when the aggregate authentication request message is valid, generating a session key and sending a message containing the session key to the machine-type communication device by means of the serving network;
(e) verifying the message containing the session key and calculating the session key by means of the machine-type communication device; and
(f) verifying the validity of the aggregate authentication by means of the group leader and the serving network.

17. The access authentication method according to claim 16, wherein the (a) includes
(a-1) selecting two random numbers (xᵢ and θᵢ) and calculating P₁ᵢ according to the following Expression by means of the machine-type communication device
$${P}_{1 i} = {T}_{{x}_{i}} ( {T}_{{k}_{i}} ( {ID}_{{SN}_{j}} ⊕ {R}_{j} ) mod q ) mod q ,$$
(a-2) calculating a 1ᵢ authentication code message (MAC₁ᵢ) according to the following Expression by means of the machine-type communication device
$${MAC}_{1 i} = {H}_{1} ( {P}_{1} , {ID}_{{SN}_{i}} , {ID}_{{MD}_{i}} , GID , {T}_{{k}_{{md}_{i}}} ( GID ⊕ {ID}_{{MD}_{i}} ⊕ {k}_{{md}_{i}} ) mod q , {T}_{{x}_{i}} ( {ID}_{{MD}_{i}} ⊕ {R}_{j} ) mod q , {T}_{{x}_{i}} ( {ID}_{{SN}_{j}} ⊕ {ID}_{{MD}_{i}} ) mod q , {θ}_{i} ) ,$$
(a-3) generating a 1ᵢ encrypted data (E₁ᵢ) using P₁ᵢ as follows by means of the machine-type communication device, and
$${E}_{1 i} = {ENC}_{{P}_{1}} ( {ID}_{{MD}_{i}} ‖ {T}_{{x}_{i}} ( {ID}_{{SN}_{j}} ⊕ {ID}_{{MD}_{i}} ⊕ GID ) mod q ‖ {T}_{{k}_{{md}_{i}}} ( GID ⊕ {ID}_{{MD}_{i}} ⊕ {k}_{{md}_{i}} ) mod q ‖ {T}_{{x}_{i}} ( {ID}_{{SN}_{i}} ⊕ {R}_{j} ) mod q ) ‖ {T}_{1 i} ‖ {θ}_{i} )$$
(a-4) sending an ID (ID_{SNj}) of the serving network, the 1ᵢ authentication code message (MAC₁ᵢ), the 1ᵢ encrypted data (E₁ᵢ), and a value of Tₓ_{ᵢ}(ID_{SN}_{ⱼ}⊕Rⱼ)mod q to a group leader (MDₙ) by means of the machine-type communication device.

18. The access authentication method according to claim 16, wherein the (b) includes
(b-1) collecting a 1ᵢ authentication code messages (IMAC₁ᵢ) from the machine-type communication devices (MDᵢ) belonging to the group and calculating a first aggregate authentication code message (AMAC₁) according to the following Expression by means of the group leader
$${AMAC}_{1} = {⊕}_{i = 1}^{n} {MAC}_{1 i} ,$$
(b-2) generating a 1ₙ encrypted data (E₁ₙ) using P₁ₙ as follows by means of the group leader, and
$${E}_{1 n} = {ENC}_{{F}_{1 i}} ( GID ‖ {ID}_{{MD}_{i}} ‖ {T}_{{x}_{i}} {ID}_{{SN}_{j}} ⊕ {ID}_{{MS}_{i}} ⊕ GID ) mod q ‖ {T}_{{k}_{{md}_{i}}} ( GID ⊕ {IDMD}_{i} ⊕ {k}_{{md}_{i}} ) mod q ‖ {T}_{{k}_{g}} ( GID ⊕ {k}_{g} ) mod q ) ‖ {T}_{{k}_{g}} ( {ID}_{SN} ⊕ GID ⊕ {R}_{j} ) mod q ‖ {T}_{{x}_{i}} ( {ID}_{{SN}_{j}} ⊕ {R}_{j} ) mod q ‖ {T}_{1 n} ‖ {θ}_{n} ‖ {AMAC}_{1} )$$
(b-3) sending the ID (ID_{SNj}) of the serving network, the 1ᵢ to 1ₙ encrypted data (E₁₁ to E₁ₙ), (Tₓ_{ᵢ}(ID_{SN}_{ᵢ}⊕Rⱼ)mod q)_{i=1, . . . n} and the value of the first aggregate authentication code message (AMAC₁) along with an authentication request to the serving network SNⱼ by means of a group leader.

19. The access authentication method according to claim 16, wherein the (c) includes
(c-1) calculating P₁′ according to the following Expression by means of the serving network;
$${P}_{1}^{′} = {T}_{{k}_{i}} ( {T}_{{x}_{i}} ( {ID}_{{SN}_{j}} ⊕ {R}_{j} ) mod q ) mod q$$
(c-2) decrypting the 1ᵢ to 1ₙ encrypted data (E₁₁ to E₁ₙ) using P₁′ and using P₁ᵢ to verify whether a 1ᵢ timestamp (T₁ᵢ) and the first aggregate authentication code message (AMAC₁) are valid by means of the serving network; and
(c-3) when the 1ᵢ timestamp (T₁ᵢ) and the first aggregate authentication code message (AMAC₁) are valid, checking whether the machine-type communication device (MDᵢ) exists in the database of the serving network (SNⱼ) using the following Expression and the ID (GID) of the group and the ID (ID_{MDi}) of the machine-type communication device by means of the serving network, and
$$\begin{matrix}{T}_{{k}_{{md}_{i}}} ( GID ⊕ {ID}_{{MD}_{i}} ⊕ {k}_{{md}_{i}} ) mod q \\ {T}_{{k}_{g}} ( GID ⊕ {k}_{g} ) mod q\end{matrix}$$
(c-4) when the machine-type communication device exists in the database of the serving network, verifying whether the aggregate authentication request message is valid by means of the serving network.

20. The access authentication method according to claim 16, wherein the (d) includes,
(d-1) calculating P₂ according to the following Expression by means of the serving network
$${P}_{2} = {T}_{{k}_{j}} ( {T}_{kg} ( {ID}_{{SN}_{j}} ⊕ GID ⊕ {R}_{j} ) mod q ) mod q ,$$
(d-2) obtaining the following value using a Chinese Remainder Theorem (CRT) by means of the serving network,
$$Θ = {\prod }_{i = 1}^{n} {θ}_{i} , {Θ}_{i} = Θ / {θ}_{i} , {c}_{i} = {Θ}_{i}^{- 1}$$
(d-3) obtaining a S value according to the following Expression by means of the serving network
$$S = ( {\sum }_{i = 1}^{n} {H}_{2} ( {ID}_{{MD}_{i}} , GID , {ID}_{{SN}_{i}} , {P}_{1 i}^{′} , {P}_{2} ) {c}_{i} {Θ}_{i} ) mod Θ ,$$
(d-4) calculating a session key (SKMDᵢ) and a serving network authentication code message (MAC_{SN}) according to the following Expression by means of the serving network
$${SK}_{{MD}_{i}} = {H}_{2} ( {T}_{{y}_{i}} ( {T}_{{x}_{i}} ( {ID}_{{SN}_{j}} ⊕ {ID}_{{MD}_{i}} ⊕ GID ) mod q ) mod q , {ID}_{{SN}_{i}} , {ID}_{{MD}_{i}} , GID , {θ}_{i} ) {MAC}_{SN} = {H}_{1} ( {P}_{2} , S , GID , {ID}_{{SN}_{i}} ) ,$$
and
(d-5) generating the second encrypted data (E₂) using the P₁ᵢ and broadcasting the second encrypted data to a machine-type communication device (MDᵢ) by means of the serving network.

21. The access authentication method according to claim 16, wherein the (e) includes
(e-1) decrypting the second encrypted data (E₂) using the P₁ to obtain a second authentication code message (MAC_{SN}), a second time stamp (T₂), Tₖ_{ᵢ}(ID_{SN}_{ᵢ}⊕GID⊕Rⱼ)mod q, and T_{y}_{ᵢ}(ID_{SN}_{ⱼ}⊕ID_{MD}_{ᵢ},GID)mod q by means of the machine-type communication device,
(e-2) verifying whether the serving network authentication code message (MAC_{SN}) and the second time stamp (T₂) are valid by means of the machine-type communication device,
(e-3) when the serving network authentication code message and second time stamp are valid, verifying whether the following Expression is correct by means of the machine-type communication device,
$${H}_{2} ( {ID}_{{MD}_{i}} , {GIDMID}_{{SN}_{j}} , {P}_{1 i} , {P}_{2}^{′} ) = S mod {θ}_{i}$$
(e-4) when the above Expression is correct, calculating a session key (SK′_{MDi}) according to the following Expression by means of the machine-type communication device MDᵢ
$${SK}_{{MD}_{i}}^{′} = {H}_{2} ( {T}_{{x}_{i}} ( {{T}_{{y}_{i}}}^{′} ( {ID}_{{SN}_{j}} ⊕ {ID}_{{MD}_{i}} ⊕ GID ) mod q ) mod q , {ID}_{{SN}_{j}} , {ID}_{{MD}_{i}} , GID , {θ}_{i} ) ,$$
(e-5) calculating a 2ᵢ authentication code message (MAC₂ᵢ) according to the following Expression by means of the machine-type communication device
$${MAC}_{2 i} = {H}_{1} ( {SK}_{{MD}_{i}}^{′} {ID}_{{SN}_{i}} , {ID}_{{MD}_{i}} , GID , {T}_{{V}_{i}} ( {ID}_{{SN}_{j}} ⊕ GID ) mod q , {T}_{{x}_{i}} ( {ID}_{{SN}_{j}} ⊕ {ID}_{{MD}_{i}} ⊕ GID ) mod q ) ,$$
and
(e-6) sending a 2ᵢ authentication code message MAC₂ᵢ to a group leader (MDₙ) by means of the machine-type communication device.

22. The access authentication method according to claim 16, wherein the (f) includes
(f-1) collecting a 2ᵢ authentication code message (MAC₂ᵢ) from a machine-type communication devices (MDᵢ) belonging to the group and calculating a second aggregate authentication code message (AMAC₂) according to the following Expression by means of the group leader
$${AMAC}_{2} = {⊕}_{i = 1}^{n} {MAC}_{2 i}$$
(f-2) sending the second aggregate authentication code message (AMAC₂) to a serving network (SNⱼ) by means of the group leader, and
(f-3) verifying whether the second aggregate authentication code message (AMAC₂) is correct by means of the serving network.
